(19) United States
(12) Patent Application Publication
(10) Pub. No.: US 2007/0015109 A1
(43) Pub. Date: Jan. 18, 2007

(54) Jaw denture

(76) Inventor: Ryoji Yamaguchi, Himeji-shi (JP)

Correspondence Address: SMITH PATENT OFFICE, 1901 PENNSYLVANIA AVENUE N W, SUITE 901, WASHINGTON, DC, 20006, US

(21) Appl. No.: 11/180,923

(22) Filed: Jul. 14, 2005

(51) Int. Cl. A61C 13/00

(52) U.S. Cl. 433/167; 433/168.1

(57) ABSTRACT

A jaw denture is provided which is capable of being attached and detached easily without pain during daily oral care. An obturator appliance is put on the mucosa side of a denture base. The obturator appliance is made into a sealed bag by using an expandable, shrinkable material that is detachably put at a reception part on the mucosa side of the denture base. An injection valve is attached to the obturator appliance to inject air inside and hold air therein. The portion projecting from the reception part of the obturator appliance is expanded in a three dimensional shape of the lost space to fill the lost space inside the bone loss portion. The air in the obturator appliance is discharged to shrink the obturator appliance and it can be taken out from the lost space. This makes it possible to clean the obturator appliance and the denture base completely.

### BACKGROUND OF THE INVENTION

1. Field of the Invention

The present invention relates to a jaw denture, and particularly, to a jaw denture capable of being attached and detached easily without pain in daily oral care.

2. Discussion of the Related Art

An upper jaw bone, a lower jaw bone, or a cheek bone may suffer a loss due to a scar or the like. In addition, for a medical treatment it is sometimes the case that the upper jaw bone or the like is removed during a necessary operation. In such a case, due to the loss of the upper jaw bones or the like, muscle and a skin structure of the face contracts to leave a scar, and a so-called cicatricial contraction often occurs. This leads to not only a serious psychological burden on the patient but also an occurrence of trismus that makes it difficult for the patient to engage in daily conversation.

Therefore, a jaw denture to reduce the cicatricial contraction has been proposed by creating a hollow obturator appliance to supplement a lost portion of the upper jaw bone or the like and this lost space using a synthetic resin material. For example, this can be accomplished by using a resin for a jaw denture base, fixing the obturator appliance to the jaw denture base, and inserting the obturator appliance from the loss portion of the upper jaw bone or the like into the inner lost space (see for example, JP-B-51-13956 and JP-A-02-124157).

However, in the case of a conventional jaw denture, which uses the synthetic resin material (for example as the resin for the jaw denture base) to mold the obturator appliance in a prescribed shape, daily oral care such as attachment and detachment of the jaw denture upon brushing teeth was very complicated. Further, the obturator appliance touched mucosa on a surface of the upper and lower jaw bones to cause acute pain to the user. In addition, the obturator appliance made of the resin was too hard to insert in the lost space in every corner, and it was not able to cope with movement and change over time of a part of the patient's face (such as a cheek).

To overcome these problems, the present applicant developed a jaw denture for putting artificial teeth on the upper jaw denture base includes an expandable and shrinkable material that is used for the jaw denture with the obturator appliance on the mucosa side of the upper jaw denture base. The obturator appliance is manufactured having a hollow three dimensional structure which nearly copies a three dimensional structure of the lost space inside the upper jaw bone loss portion upon expansion. The obturator appliance is connected in an airtight fashion to a reception part on the mucosa side of the upper jaw denture base and holds the obturator appliance by injecting gas therein by an injection valve. The obturator appliance is expanded to be made into a prescribed three dimensional structure to fill the lost space inside the lost portion of the upper jaw bone. The obturator appliance is also contracted by releasing the gas from the injection valve so as to enable the obturator appliance to take out the jaw denture from the lost space inside the lost portion of the upper jaw bone. The present applicant filed a patent application with respect to this jaw denture (see Japanese Patent Application Publication No. 2004-194932).

The above-described jaw denture is superior to the conventional one in that the user can attach or detach it easily without pain during daily oral care. However, in the jaw denture according to the above-identified application, stains easily remain at a portion where the obturator appliance is attached to the upper jaw denture base, and cleaning is difficult. These remain issues need to be resolved.

### SUMMARY OF THE INVENTION

Taking the foregoing problems into consideration, an object of the present invention is to provide a jaw denture capable of being easily attached to and detached from a lost space inside a bone loss portion of the upper and lower jaw without pain during daily oral care, and further, to provide a jaw denture capable of being easily cleaned in every corner.

The jaw denture according to the present invention is characterized as follows. The artificial teeth are arranged in a denture base. The obturator appliance is put on the mucosa side of the above-described denture base. The obturator appliance is detachably arranged at a reception part on the mucosa side of the denture base. The obturator appliance is made as a sealed bag by using an expandable and shrinkable material. A portion projecting from the reception part of the denture base of the obturator appliance is formed in the hollow three dimensional structure nearly copying the three dimensional structure of the lost space inside a bone loss portion upon expansion. An injection valve is attached to the obturator appliance to inject air inside and hold air therein. The injection valve is supported by the reception part or the denture base. By injecting air into the obturator appliance by means of the injection valve, the portion projecting from the reception part of the denture base of the obturator appliance is expanded into the three dimensional shape of the lost space to fill the lost space inside the bone loss portion. The air in the obturator appliance is discharged from the injection valve to shrink the obturator appliance and the obturator appliance can be taken out from the lost space inside the bone loss portion. Thus, it is possible to clean the obturator appliance and the denture base by taking out the obturator appliance from the reception part of the denture base.

One of the characteristics of the present invention is that the obturator appliance is expanded by injecting gas and the obturator appliance is contracted by discharging the gas.

Thereby, by contracting the obturator appliance, the obturator appliance can be easily inserted into and taken out from the inner lost space from the bone loss portion of the upper and lower jaws, and at the same time, by expanding the obturator appliance, it is possible to fill the lost space inside the bone loss portion.

As a result, the cicatricial contraction can be reliably reduced and prevented, and it is possible to attach and detach the jaw denture easily without pain in daily oral care. Further, the user does not suffer from acute pain due to touching of the obturator appliance to the mucosa on a surface of the upper and lower jaw bones. In addition, since the obturator appliance can be expanded and contracted, the obturator appliance can immediately keep up with movement of the patient's face and can change over time.

Another characteristic of the present invention is that the obturator appliance is made into a sealed bag and it can be attached to and detached from a reception part on the mucosa side of the denture base.

Therefore, by removing the obturator appliance from the reception part of the denture base, it is possible to clean the obturator appliance and the denture base in every corner and to keep the entire denture clean.

In addition, if the loss of the upper and lower jaw bones is small, there may be no space to dispose the injection valve. In such a case, by supporting the obturator appliance, which is expanded into a balloon at the denture base, the lost space of the bone loss part is filled.

In other words, the present invention may provide a jaw denture arranging artificial teeth at a denture base and putting an obturator appliance on the mucosa side of the denture base, wherein the obturator appliance is supported by a support part on the mucosa side of the denture base and the obturator appliance is made into a sealed bag by using an expansible and shrinkable material; a portion projecting from the support part of denture base of the obturator appliance is formed in a hollow three dimensional structure nearly copying a three dimensional structure of a lost space of a bone loss portion to fill the lost space.

The material of the obturator appliance need only be expansible and shrinkable. For example, various latex and polyester or the like emulsifying a polymer molecule such as a natural rubber, a synthetic rubber or plastic or the like may be used.

The denture base and the artificial teeth may be conventional and publicly known. The reception part of the denture base may be integrally formed when manufacturing the denture base, or it may be separately made to be fixed to the denture base. Particularly, in the latter case, by fixing the reception part to the denture base that has been already used, the jaw denture according to the present invention can be made.

The structure or system of the injection valve does not matter as long as it can inject and hold the gas, and then, it can discharge it by the discharging operation. In addition, since this injection valve needs to be able to inject the gas into the obturator appliance and discharge the gas with the obturator appliance set in the lost space inside the bone loss part of the upper jaw (and/or the lower jaw), and further, to be supported stably, it is preferable that this injection valve is inserted through an insertion hole that is formed on the denture base or the reception part.

In the case of the obturator appliance made of the expansible and shrinkable material, for example, various latex and polyester or the like emulsifying a polymer molecule such as a natural rubber, a synthetic rubber or plastic or the like, if the obturator appliance constantly gets wet by saliva in a mouth, a pin hole is easily generated in the obturator appliance and deterioration of durability is anticipated. Therefore, it is preferable that a surface of the obturator appliance is coated with a soft synthetic resin material that is tolerant to saliva, for example, polyurethane.

In addition, it is feared that air is leaked from the attaching part of the injection valve due to difference in material between the injection valve and the obturator appliance. Therefore, it is preferable that a tubular attaching part is provided on the obturator appliance, the injection valve is injected in the attaching part, and a heat shrinkable tube is fit in the outside of the attaching part to shrink the injection valve so as to attach the injection valve to the obturator appliance airtight. In this case, if a cord made of, for example, a synthetic resin is wound around to provide a circular projection on the external surface of the injection valve, the injection valve strongly sticks fast to the attaching part so as to further improve air tightness.

In the case of manufacturing the jaw denture by putting the artificial teeth on the denture base and putting the obturator appliance on the mucosa side of the denture base. The jaw denture is made into a sealed bag by using the expandable and shrinkable material in such a manner that a model that nearly copies the three dimensional structure of a lost space inside the bone loss portion of the upper and/or lower jaws is created. The model is shaped to fit in the reception part of the denture base in a concave shape. The expandable and shrinkable material is applied or attached on the surface of the models and the expandable and shrinkable material is peeled off from the models. The two models are bonded with each other by an adhesion bond or the like. In this jaw denture, the obturator appliance is made in a hollow structure in such a manner that a portion projecting from the reception part of the denture base is formed in a hollow three dimensional structure nearly copying the three dimensional structure of the lost space inside the bone loss portion upon expansion and is capable of being taken out from the lost space inside the bone loss portion upon shrinking. An injection valve is provided to inject the gas into or discharge gas from the obturator appliance. The obturator appliance is then detachably attached to the reception part of the denture base.

The model of the lost space can be made with a plaster cast by, for example, obtaining an impression of the lost space inside the bone loss portion of the upper and/or lower jaws using a publicly known impression material and by using the obtained impression. At this stage, one should check the spots where the obturator appliance touches the mucosa and where the obturator appliance requires strength, they should modify the model. The model of the concave portion at the reception part can be also made in the same way as the model of the lost space.

The expandable and shrinkable material may be applied on the surface of the model of the lost space, and by soaking the model in the expandable and shrinkable material, the material may be attached on the surface of the model.

### BRIEF DESCRIPTION OF THE DRAWINGS

FIG. 1A and FIG. 1B are perspective views showing an assembling state according to a preferred embodiment of a jaw denture of the present invention;

FIG. 2A and FIG. 2B are sectional views showing an example of attaching an injection valve according to the above-described embodiment;

FIG. 3 is a perspective view showing the assembled state of the above-described embodiment;

FIG. 4A and FIG. 4B illustrate a second embodiment according to the present invention; and

FIG. 5A and FIG. 5B illustrate an assembling state according to the second embodiment of the present invention.

### DETAILED DESCRIPTION OF THE PREFERRED EMBODIMENTS

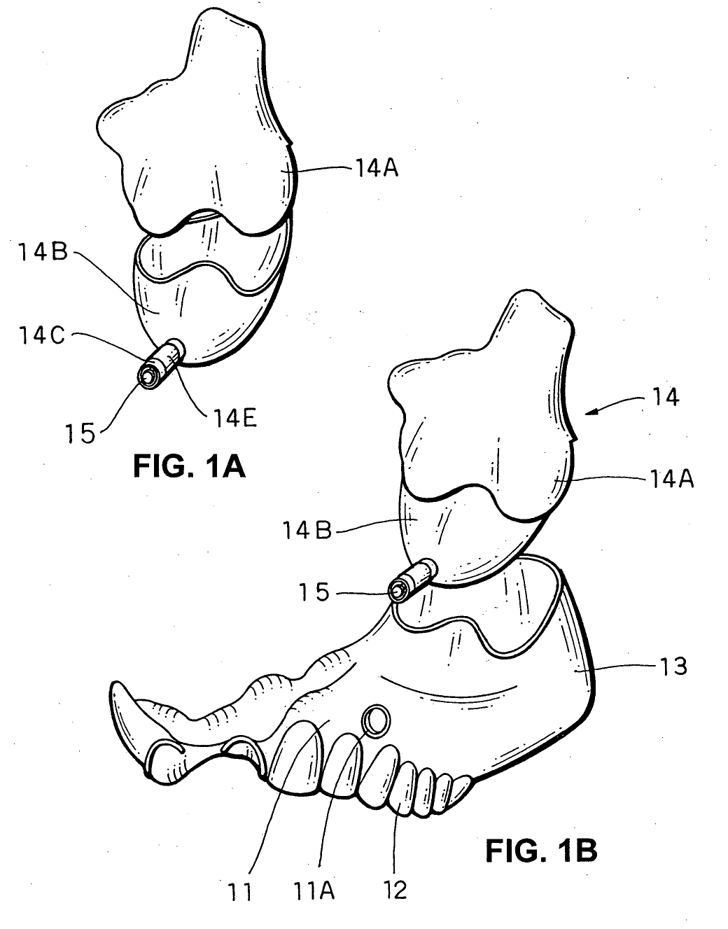

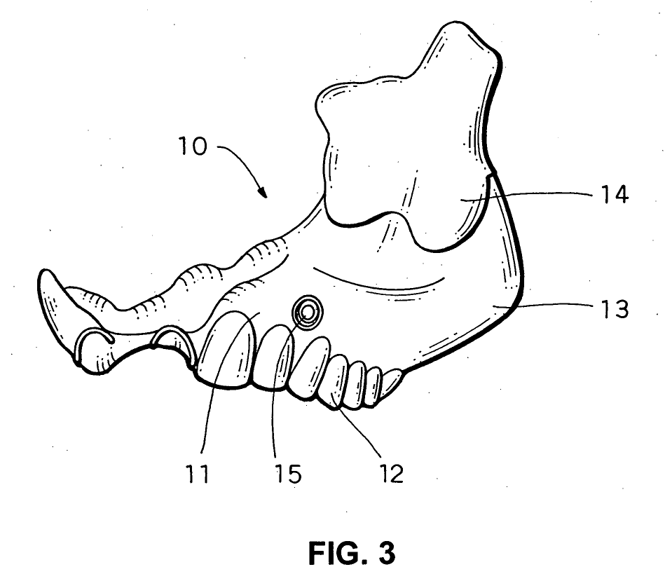

With reference to the embodiments, the present invention will be described in detail below. FIGS. 1 to 3 illustrate a preferred embodiment of a jaw denture according to the present invention. In the drawings, a jaw denture 10 is structured in such a manner that artificial teeth 12 are fixed on a denture base 11 and a lower part 14B of an obturator appliance 14 is detachably fit in a reception part 13 on the mucosa side of the denture base 11.

The denture base 11 is made of resin, and the artificial teeth 12 are made of resin teeth or ceramic teeth. These are publicly known in the art so their detailed explanation has been omitted.

The obturator appliance 14 is made as a completely sealed bag. Its lower part 14B is shaped so as to be fit in a concave portion of the reception part 13 on the mucosa side of the denture base 11. On the other hand, an upper part 14A, namely a portion projecting from the reception part 13 of the denture base 11 is formed in a hollow three dimensional structure nearly copying a three dimensional structure of the lost space inside a bone loss portion of an upper jaw upon expansion. This upper part 14A is made expandable and shrinkable by using a commercially available latex (for example, MASK LATEX IUSQt. manufactured by SPECIAL EFFECT SUPPLY CO.). Further, the surface of the obturator appliance 14 is coated with a soft synthetic resin material that is tolerant to saliva, for example, polyurethane resin.

In addition, an injection valve 15 is attached to the denture base 11. That is, at the lower part 14B of the obturator appliance 14 has a tubular attaching part 14C which is integrally formed therein. A projecting portion is formed at the outside of the injection valve 15 by, for example, winding a latex-made cord 14D around it. The injection valve 15 is then inserted into the attaching part 14C. A heat shrinkable tube 14E is then fit around the outside of the attaching part 14C and is then shrunk. Thus, the injection valve 15 is attached to the obturator appliance 14 in an airtight manner.

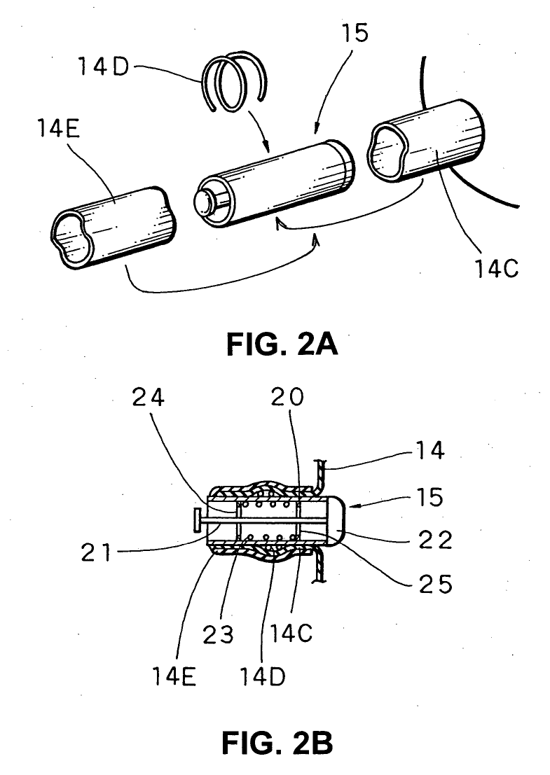

This injection valve 15 injects air (gas) in the obturator appliance 14 to hold air therein and discharge it if necessary. For example, as shown in FIG. 2, the injection valve 15 can be structured in such a manner that a rod 21 is inserted through a tube 20, a valve 22 is disposed at one end of the rod 21 to block off an opening of the tube 20, and a spring member 23 that is used to bias the valve 22 in a closed direction is externally inserted around the rod 21 between stop members 24 and 25.

The injection valve 15 operates to inject and discharge air to and from an oral cavity. Therefore, the injection valve 15 is inserted through a region where it can be operated in the oral cavity. Specifically, a through hole 11A is formed in the denture base 11 supports the injection valve there.

In the case of manufacturing the jaw denture according to the present embodiment, a plaster cast is molded from impressions obtained using, for example, an alginate impression material and taking impressions of an alveolus and the upper jaw bone loss portion. By using this cast, a waxy denture is manufactured on which the artificial teeth are arranged and a gum is formed. The waxy denture is buried in the plaster, and the wax is melted to be removed. Then, by filling, for example, a metallic resin in the space, polymerization is performed by irradiating with microwaves, for example, using a microwave oven. Then, the denture base 11 is obtained, in which the artificial teeth 12 are fixed and the reception part 13 is formed on the mucosa side and taken out. The manufacturing method of the denture is the same as the conventional method except for forming the reception part 13, so that the denture according to the present invention can also be manufactured by other methods.

The through hole 11A is made in a prescribed region of the obtained denture base 11. For example, the through hole 11A can be in a region where it is easy to operate in the oral cavity, such as toward the reception part 13, and then, the denture base 11 is polished.

On the other hand, using the alginate impression material, an impression of a lost space further inside than the upper jaw bone loss portion is also obtained. For example, using the plaster material, a model of the lost space is molded from the obtained impression. In this case, one should check the spots where the obturator appliance 14 touches the mucosa and causes pain and where the obturator appliance 14 requires strength, and one should modify the model so that these regions are made in a concave shape or a convex shape.

In the same way, for example, using the alginate impression material, an impression of the space in the reception part 13 of the denture base 11 is also obtained. For example, by using the plaster material, a model copying the inner space of the reception part 13 is molded from the obtained impression. In this case, the model is modified so that the entire lower part 14B of the obturator appliance 14 or the upper part (it is preferably made thick to prevent it from being taken off from the reception part 13 when the upper part 14A is shrunk) is tightly fit in the reception part 13, or that the attaching part 14C is formed in the lower part 14B of the obturator appliance 14.

When the model is obtained in this way, latex (for example, MASK LATEX IUSQt. manufactured by SPECIAL EFFECT SUPPLY CO.) is applied to the obtained model. When the latex hardens, the upper part 14A and the lower part 14B of the obturator appliance 14 are obtained by peeling it off from the model. Therefore, after bonding the upper part 14A with the lower part 14B, by soaking them in a liquid polyurethane and drying them, the obturator appliance 14 is obtained as a substantially sealed bag.

Next, or before bonding the upper part 14A with the lower part 14B, by winding the latex-made cord 14D around the outside of the injection valve 15, inserting this injection valve 15 into the tubular attaching part 14C of the lower part 14B, covering it with the heat shrinkable tube 14E over, and heating the tube 14E to shrink, the injection valve 15 is attached in an airtight manner to the attaching part 14C of the obturator appliance 14 by the tube 14E.

The obturator appliance 14 that is obtained in this way is detachably fit in the reception part 13 of the denture base 11 and is supported by inserting the injection valve 15 through the through hole 11A of the denture base 11. Lastly, one should inject air from the injection valve 15 and check for air leaks. If there is no air leak, one should let a patient try the jaw denture 10 according to the present embodiment and check to see if the patient feels pain upon attaching and detaching the jaw denture 10 or upon occluding. If the patient feels no pain, the intended jaw denture 10 is obtained.

In the case of fitting the jaw denture 10 according to the present embodiment, when the obturator appliance 14 is shrunk, the jaw denture 10 is fit in the oral cavity while inserting the obturator appliance 14 in the inner lost space from the upper jaw bone loss portion. Then, since the obturator appliance 14 is shrunk, the obturator appliance 14 does not touch the mucosa of the upper jaw bone loss portion, so that the user hardly feels pain and the obturator appliance 14 can be easily inserted from the upper jaw bone loss portion to its inner lost space.

When the jaw denture 10 is set, air is injected from the injection valve 15. Then, the rod 21 of the injection valve 15 is pushed against a spring force of the spring member 23 to cause the valve 22 to open the opening of the tube 20 and air is injected in the obturator appliance 14. Then, the upper part 14A of the obturator appliance 14 is expanded to fill the lost space inside the upper jaw bone loss portion. If injection of air is stopped, the rod 21 of the injection valve 15 is pushed in front by the spring force of the spring member 23, the valve 22 seals the opening of the tube 20 while air is held in the obturator appliance 14, and the upper part 14A of the obturator appliance 14 is maintained in the expanded three dimensional shape to provide expansion to the surrounding muscles and skin structure of the patient's face. This technique of using this jaw denture reduces cicatricial contraction.

In the case of taking off the jaw denture 10, if the rod 21 of the injection valve 15 is pushed, the valve 22 opens the opening of the tube 20, air in the obturator appliance 14 is discharged to the outside, and the upper part 14A of the obturator appliance 14 is shrunk. Therefore, the jaw denture 10 may be taken out to the outside of the oral cavity as usual after that process. In this case, since the upper part 14A of the obturator appliance 14 is shrunk, when taking the jaw denture 10 out of the user's mouth, the obturator appliance 14 does not touch the mucosa of the upper jaw bone loss portion and the lost space so that the user hardly feels any pain.

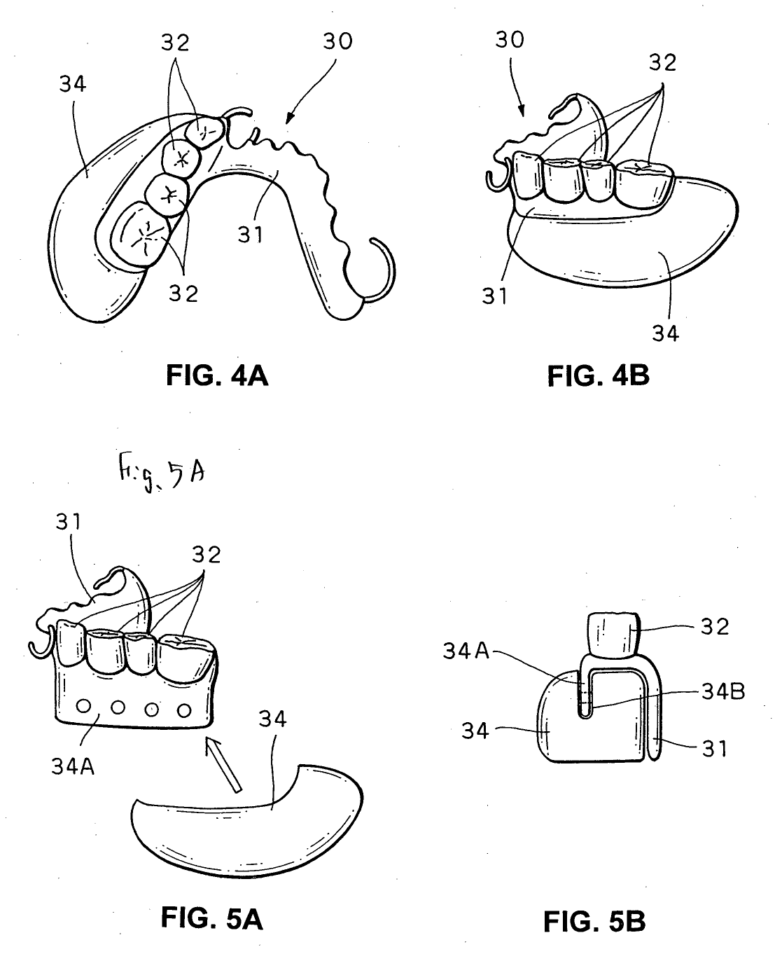

FIG. 4 and FIG. 5 illustrate a second embodiment of the present invention. In the drawings, a jaw denture 30 is formed in such a manner that artificial teeth 32 are fixed at a denture base 31 and an obturator appliance 34 is supported by a support part (reception part) 34A on the mucosa side of the denture base 31. The denture base 31 is made of resin, and the artificial teeth 32 are made of resin teeth or ceramic teeth.

The obturator appliance 34 is made as a completely sealed bag and on its upper part, a concave portion 34B is formed so as to be fit in the support part 34A on the mucosa side of the denture base 31. On the other hand, a lower part, namely, a portion projecting from the support part 34A of the denture base 31 of the obturator appliance 34 is formed in a hollow three dimensional structure nearly copying a three dimensional structure of the lost space of the bone loss portion so as to fill the lost space.

This obturator appliance 34 is made expansible and shrinkable by using a commercially available latex (for example, MASK LATEX IUSQt. manufactured by SPECIAL EFFECT SUPPLY CO.). Further, the surface of the obturator appliance 34 is coated with a soft synthetic resin material that is tolerant to saliva, for example, polyurethane resin.

In the case of manufacturing the jaw denture according to the present embodiment, for example, by using the alginate impression material and obtaining the impressions of an alveolus and the lower jaw bone loss portion, a plaster cast can be molded from the obtained impressions. By using this cast, a waxy denture on which the artificial teeth are arranged, a gum is formed, and a support part is disposed on the mucosa side is manufactured. The waxy denture is buried in the plaster, and the wax is melted to be removed. Then, filling, for example, by using a metallic resin in the space, polymerization is performed by using microwave irradiation, for example, a microwave oven. Then, the denture base 31 in which the artificial teeth 32 are fixed and the support part 34A formed on the mucosa side is obtained. Then the denture base 31 is polished.

On the other hand, using the alginate impression material, an impression of a lost space of the lower jaw bone loss portion is also obtained. For example, by using plaster material, a model of the lost space is molded from the obtained impression. In this case, by checking the spots where the obturator appliance 34 touches to cause pain and where the obturator appliance 34 requires strength, the model can be modified so that these regions can be made in a concave shape or a convex shape.

Thus, when the model is obtained, by applying latex (for example, MASK LATEX IUSQt. manufactured by SPECIAL EFFECT SUPPLY CO.) to the obtained model, waiting until the latex slightly hardens, peeling it off from the model, the obturator appliance 34 can be obtained so as to fill the opening of the obturator appliance 34 that is used for taking out the model.

The obturator appliance 34 that is obtained in this way is fit and supported in the support part 34A of the denture base 31. Lastly, air is injected in the obturator appliance 34 using an injector or the like, and the opening for injecting air therein is then blocked off. Then, one should check to see for any air leaks. If there are no air leaks, one should let a patient try the jaw denture 30 according to the present embodiment. Then, one should check to see if the patient feels pain upon attaching and removing the jaw denture 30, or occluding. If the patient feels no pain, after the obturator appliance 34 is soaked in liquid polyurethane and then dried, the intended jaw denture 30 is obtained.

In the case of fitting the jaw denture 30 according to the present embodiment, the jaw denture 30 is fit in the oral cavity while inserting the obturator appliance 34 in the lost space of the lower jaw bone loss portion.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

1. A jaw denture comprising:
a denture base having a reception portion therein;
at least one artificial tooth arranged on said denture base;
an obturator appliance disposed on a mucosa side of said denture base, wherein said obturator appliance is partially disposed in said reception part of said denture base and is detachable therefrom, said obturator appliance includes a sealed bag made of an expandable and shrinkable material, a portion of said obturator appliance projects from said reception part of said denture base and the portion includes a three dimensional structure substantially matching a three dimensional structure of a lost space inside a bone loss portion when said obturator appliance is expanded;
an injection valve attached to said obturator appliance to inject air inside and hold air therein; and said injection valve is supported by at least one of said reception part and said denture base;
a tubular attaching part provided on said obturator appliance, said injection valve being disposed in said attaching part; and
a heat shrinkable tube disposed around an outside surface of said attaching part so that said injection valve is attached in an airtight manner to said obturator appliance;
whereby injecting air in said obturator appliance through said injection valve expands said portion projecting from said reception part in a three dimensional shape of the lost space to fill the lost space inside the bone loss portion; and whereby the air in said obturator appliance is discharged from said injection valve to shrink said obturator appliance so as to be taken out from said lost space inside said bone loss portion.

2. The jaw denture as defined in claim 1, wherein a surface of said obturator appliance is coated with a soft synthetic resin material having saliva resistant characteristics.

3. (canceled)

4. The jaw denture as defined in claim 1, wherein said injection valve is disposed in a through hole that is formed in at least one of said reception part and said denture base.

5. A jaw denture comprising:
a denture base having a reception portion therein;
at least one artificial tooth arranged on said denture base;
an obturator appliance disposed on a mucosa side of said denture base, wherein said obturator appliance is supported by a support part on said mucosa side of said denture base, said obturator appliance includes a first portion and a second portion, said first portion and said second portion being disposed on opposite sides of said support part, and said obturator appliance includes a sealed bag having an expandable and shrinkable material, said support part includes a portion projecting from said support part formed in a hollow three dimensional structure substantially similar to a three dimensional structure of a lost space of a bone loss portion thereby filling the lost space.

6. The jaw denture as defined in claim 5, wherein a surface of said obturator appliance is coated with a soft synthetic resin material having saliva resistant characteristics.
